(19) United States
(12) Patent Application Publication
(10) Pub. No.: US 2024/0095469 A1
(43) Pub. Date: Mar. 21, 2024

(54) IMAGE FORMING APPARATUS, IMAGE FORMING METHOD, AND NON-TRANSITORY RECORDING MEDIUM STORING COMPUTER PROGRAM

(71) Applicant: TOSHIBA TEC KABUSHIKI KAISHA, Tokyo (JP)

(72) Inventor: Yutaka Kukitsu, Sunto Shizuoka (JP)

(21) Appl. No.: 17/947,200

(22) Filed: Sep. 19, 2022

(51) Int. Cl. G06F 40/58; G06F 40/109; G06F 40/263; G06K 15/02; H04N 1/32

(52) U.S. Cl. CPC G06F 40/58; G06F 40/109; G06F 40/263; G06K 15/1827; H04N 1/3232

(57) ABSTRACT

An image forming apparatus includes an instruction-information acquiring unit, a translation-result-information acquiring unit, a font-data acquiring unit, an image-formation control unit, and an image forming unit. The instruction-information acquiring unit acquires information indicating a first character string described in a first language and information indicating a second language different from the first language. The translation-result-information acquiring unit acquires, from a translation service provision server, information indicating a second character string, which is a character string obtained by translating the first character string into the second language. The font-data acquiring unit acquires font data of the second language from a font data distribution server. The image-formation control unit generates a synthetic image obtained by adding the second character string having a font based on the font data to a formation target image.

### FIELD

Embodiments described herein relate generally to an image forming apparatus, an image forming method, and a non-transitory recording medium storing a computer program.

### BACKGROUND

There is an image forming apparatus that can add a watermark to an image if forming the image on a sheet. The sheet is, for example, paper or a film. The image forming apparatus is, for example, a multi-function peripheral (MFP), a copying machine, or a printer. The image forming apparatus forms, on the sheet, an image obtained by superimposing a watermark on an image to be formed on the sheet. In the following explanation, the image to be formed on the sheet is referred to as “formation target image”.

The formation target image is an image including content such as a sentence or a photograph. The watermark is a character string or a pattern used as a mark such as a glyph, an icon, a logo, or an illustration. If the image is formed on the sheet, the watermark is inserted in the background of the content. The watermark is inserted for the purpose of, for example, protecting the copyright of the content and preventing unpermitted reuse or alteration. Besides, the watermark is sometimes added for the purpose of clear indication of a disclosure range, clear indication of a use, version management, brand recognition improvement, or marketing.

The character string used as the watermark is a character string such as “strictly confidential”, “company secret”, “draft”, “original”, “copy”, “reproduction prohibited”, “customer copy”, “store copy”, or “filing copy”. There is also an image forming apparatus that can add, as a watermark, any character string designated by a user besides a watermark formed by a character string prepared in advance. A general image forming apparatus in the past can receive an input of a character string by a predetermined language such as a native language or English and generate a watermark.

However, in the image forming apparatus in the past, a language of the character string that can be used as the watermark is limited to the predetermined language. For example, the image forming apparatus in the past can add only the watermark formed by the character string of English or the native language to the formation target image. Accordingly, a person except a person who can understand the predetermined language to which the image forming apparatus is adapted sometimes cannot recognize a meaning of a watermark included in an image formed on a sheet.

### DESCRIPTION OF THE DRAWINGS

FIG. 1 is a schematic diagram illustrating a specific example of a multi-function peripheral system;

FIG. 2 is a schematic diagram illustrating an example of a translation service provided by a translation service provision server;

FIG. 3 is an exterior view illustrating an overall configuration example of an image forming apparatus;

FIG. 4 is a block diagram illustrating a hardware configuration of the image forming apparatus;

FIG. 5 is a block diagram illustrating a functional configuration of a control unit;

FIG. 6 is a block diagram illustrating the configuration of an auxiliary storage device;

FIG. 7 is a schematic diagram illustrating an example of a watermark setting screen;

FIG. 8 is a flowchart illustrating an example of an operation of the image forming apparatus;

FIG. 9 is a block diagram illustrating a hardware configuration of a terminal device;

FIG. 10 is a block diagram illustrating a hardware configuration of the translation service provision server; and

FIG. 11 is a block diagram illustrating a hardware configuration of a font data distribution server.

### DETAILED DESCRIPTION

An aspect of embodiments is to provide an image forming apparatus, an image forming method, and a non-transitory recording medium storing a computer program that can add, to a formation target image, a watermark obtained by translating a character string into an appropriate language according to a distribution target person of a sheet.

An image forming apparatus in an embodiment includes an instruction-information acquiring unit, a translation-result-information acquiring unit, a font-data acquiring unit, an image-formation control unit, and an image forming unit. The instruction-information acquiring unit acquires information indicating a first character string described in a first language and information indicating a second language different from the first language. The translation-result-information acquiring unit acquires, from a translation service provision server, information indicating a second character string, which is a character string obtained by translating the first character string into the second language. The font-data acquiring unit acquires font data of the second language from a font data distribution server. The image-formation control unit generates a synthetic image obtained by adding the second character string having a font based on the font data to a formation target image. The image forming unit forms the synthetic image on a sheet.

An image forming apparatus, an image forming method, and a non-transitory recording medium storing a computer program in an embodiment are explained below with reference to the drawings.

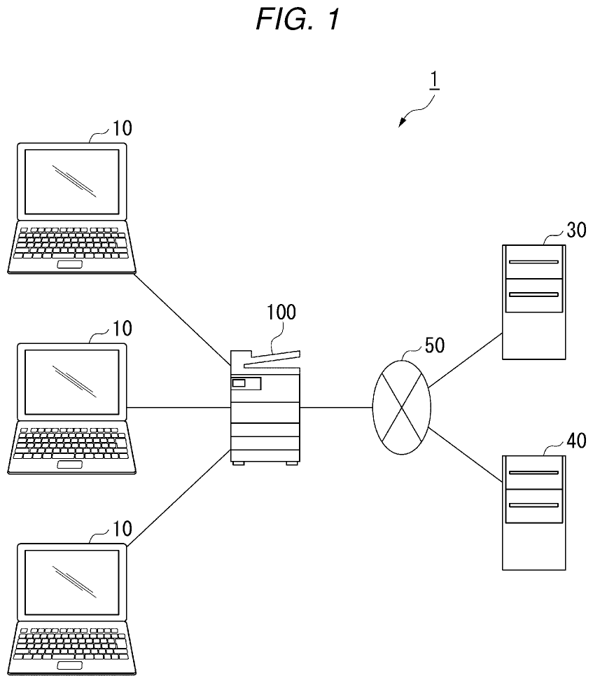

FIG. 1 is a schematic diagram illustrating a specific example of a multi-function peripheral system 1 in this embodiment. The multi-function peripheral system 1 receives designation of an input image data file, a watermark including a character string, and a language from a user. The multi-function peripheral system 1 forms, on a sheet, a synthetic image obtained by adding the designated watermark to a formation target image based on image formation data included in the designated input image data file. At this time, according to necessity, the multi-function peripheral system 1 adds, to the synthetic image, a watermark obtained by converting the character string included in the designated watermark into a character string of the designated language. That is, the multi-function peripheral system 1 in this embodiment makes it possible to translate the language of the character string included in the watermark to be added into a desired language.

The multi-function peripheral system 1 is also capable of adding a watermark not including a character string to the formation target image. However, in this embodiment explained below, the multi-function peripheral system 1 adds the watermark including the character string to the formation target image.

As illustrated in FIG. 1, the multi-function peripheral system 1 includes an image forming apparatus 100, a terminal device 10, a translation service provision server 30, a font data distribution server 40, and the Internet 50. The image forming apparatus 100 is an MFP. The image forming apparatus 100 may be another image forming apparatus such as a copying machine or a printer. The configuration of the image forming apparatus 100 is explained in detail below.

The terminal device 10 is a PC. The terminal device 10 may be another terminal device such as a tablet computer or a smartphone. The terminal device 10 is communicatively connected to the image forming apparatus 100 via a communication line such as a LAN (Local Area Network). Another device such as a print distribution server may be interposed in a communication path between the terminal device 10 and the image forming apparatus 100. In FIG. 1, as an example, three terminal devices 10 are connected to the image forming apparatus 100. However, the number of terminal devices 10 connected to the image forming apparatus 100 can be set to any number.

The terminal device 10 is used if a user instructs, from the terminal device 10, the image forming apparatus 100 to form an image on a sheet. That is, the terminal device 10 is used if the image forming apparatus 100 is used as a printer. If the image forming apparatus 100 is used as only a copying machine, the multi-function peripheral system 1 may not include the terminal device 10.

A printer driver is installed in the terminal device 10. The terminal device 10 receives input operation by the user and generates an input image data file and print instruction information based on the input operation. The terminal device 10 transmits the generated input image data file and the generated print instruction information to the image forming apparatus 100.

The input image file data is data including one or a plurality of image formation data. The image formation data is data indicating a formation target image, which is an image of content desired by the user to be formed as an image on a sheet. The content is a document, a pattern, a picture, a photograph, or a combination of the foregoing.

The print instruction information is information defining information for determining what kind of processing the image forming apparatus 100, which acquires the image formation data, performs on the image formation data. The print instruction information includes an instruction for designating a character string included in a watermark and a language. The character string included in the watermark may be a character string input by the user or may be a character string selected out of character strings prepared in advance.

The print instruction information may include an instruction for designating a type of a watermark. The type of the watermark is a type such as a font, a style (thickness of a character, presence or absence and a type of an enclosure line, presence or absence of an underline, or the like), a size, and a color of a character string included in the watermark. The print instruction information may include an instruction for designating a position, a rotation angle, a transparency degree, and the like of the watermark on a sheet on which an image is formed.

The translation service provision server 30 and the font data distribution server 40 are information processing devices such as a general-purpose computer. The translation service provision server 30 and the font data distribution server 40 may be configured as an integrated information processing device. The translation service provision server and the font data distribution server 40 are communicatively connected to the image forming apparatus 100 via the Internet 50. The translation service provision server 30 and the font data distribution server 40 are, for example, Cloud servers that provide Cloud-type services on the Internet 50.

However, without being limited to the configurations explained above, the translation service provision server 30 and the font data distribution server 40 may be communicatively connected to the image forming apparatus 100 via a LAN or the like. Alternatively, functions of the translation service provision server 30 and the font data distribution server 40 may be installed in a computer of the image forming apparatus 100.

The translation service provision server 30 has a translation function that can translate a language of an input character string into designated another language. That is, the translation service provision server 30 is a server that provides a translation service. As a technique for realizing the translation function, any existing technique can be used.

The translation service provision server 30 acquires translation request information transmitted from the image forming apparatus 100. The translation request information includes a character string and information indicating a language. A language (a first language) used in the character string included in the translation request information is a language different from a language (a second language) included in the translation request information. That is, the translation request information is information that means requesting translation of the character string from the first language to the second language.

The translation service provision server 30 converts the character string included in the translation request information into a character string of the language (the second language) included in the translation request information. The translation service provision server 30 returns translation result information indicating the converted character string to the image forming apparatus 100.

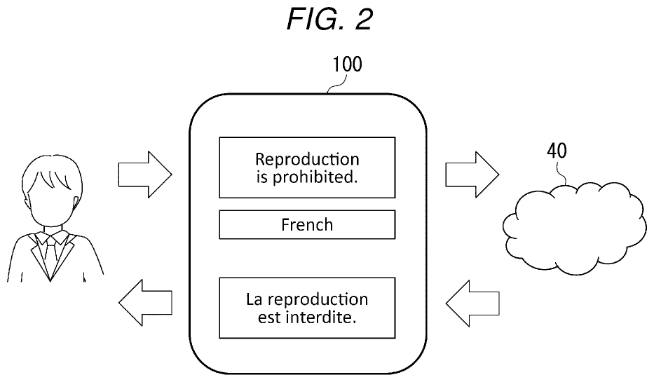

FIG. 2 is a schematic diagram illustrating an example of a translation service provided by the translation service provision server 30. For example, the translation service provision server 30 acquires, from the image forming apparatus 100, translation request information indicating an English character string “Reproduction is prohibited.” and a name of a language “French” designated by the user. The translation service provision server 30 converts the English character string into a character string “La reproduction est interdite.” having the same meaning in French. The translation service provision server 30 returns the French character string to the image forming apparatus 100.

The translation service provided by the translation service provision server 30 may be, for example, a commercial translation service. The translation service provided by the translation service provision server 30 may be a translation service provided by, for example, Google LLC (registered trademark) or Excite Japan Co., Ltd. (registered trademark).

The font data distribution server 40 stores font data (data representing fonts) of various languages. The font data distribution server 40 has a distribution function for transmitting font data to a request source according to a request. That is, the font data distribution server 40 is a server that distributes font data. The font data distribution server 40 acquires font data request information transmitted from the image forming apparatus 100. The font data request information includes information indicating a language. The translation service provision server 30 returns font data of the language included in the font data request information.

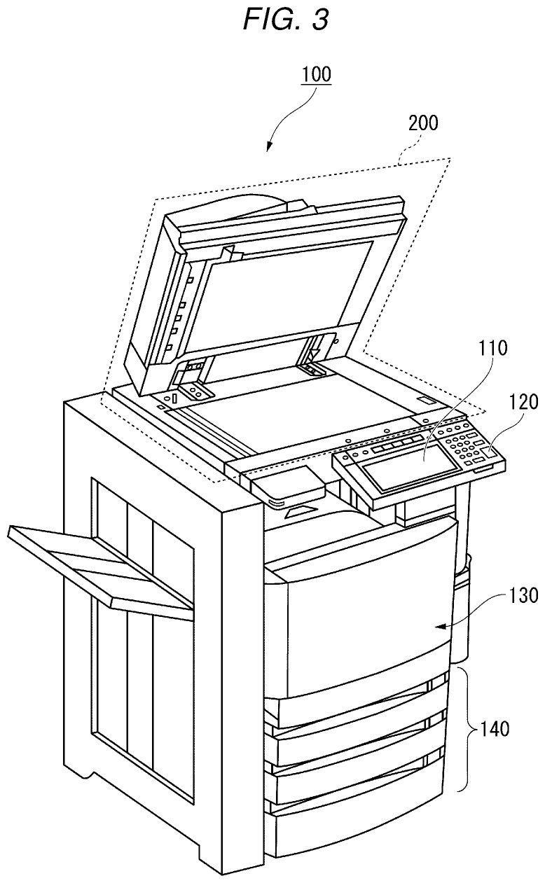

Subsequently, the configuration of the image forming apparatus 100 is explained with reference to FIG. 3. FIG. 3 is an exterior view illustrating an overall configuration example of the image forming apparatus 100. The image forming apparatus 100 in this embodiment is the MFP as explained above. The image forming apparatus 100 includes a display 110, a control panel 120, a printer unit 130, a sheet storing unit 140, and an image reading unit 200.

The display 110 is a display device such as a liquid crystal display (LCD) or an organic EL (Electro Luminescence) display. The display 110 displays various kinds of information concerning the image forming apparatus 100 under control by a control unit 101 explained below. Note that the display 110 may be an input and output device such as a touch panel integrated with the control panel 120 explained below.

The control panel 120 is an input device that receives input operation of the user. The control panel 120 includes, for example, a plurality of input buttons. If the control panel 120 is, for example, a touch panel integrated with the display 110, the input buttons may be images displayed on the display 110. The control panel 120 outputs an operation signal corresponding to the input operation of the user to the control unit 101.

For example, the control unit 101 generates, based on an operation signal acquired from the control panel 120, copy instruction information based on the input operation. Like the print instruction information, the copy instruction information is information defining information for determining what kind of processing the image forming apparatus 100, which generates image formation data by reading an image, performs on the image formation data. The copy instruction information includes an instruction for designating a character string included in a watermark and a language. The character string included in the watermark may be a character string input by the user or may be a character string selected out of character strings prepared in advance.

The copy instruction information includes an instruction for designating a type of the watermark. The type of the watermark is a type such as a font, a style (thickness of a character, presence or absence and a type of an enclosure line, presence or absence of an underline, or the like), a size, and a color of the character string included in the watermark. The print instruction information may include an instruction for designating a position, a rotation angle, a transparency degree, and the like of the watermark on a sheet on which an image is formed.

For example, the control unit 101 controls the image reading unit 200 and the printer unit 130 based on the operation signal acquired from the control panel 120 and causes the image reading unit 200 and the printer unit 130 to execute copy processing.

The image reading unit 200 reads, based on brightness or darkness of light, an image formed on a document placed on a document stand and generates image formation data, which is digital data. The image reading unit 200 outputs the generated image formation data to the control unit 101. The control unit 101 generates an input image data file including the input image formation data and causes an auxiliary storage device 103 explained below to store the input image data file. The control unit 101 may output the input image data file to a storage device or a storage medium on the outside via, for example a network. The control unit 101 may directly output the input image data file to the printer unit 130 without causing the storage device or the like to store the input image data file.

The printer unit 130 forms an image on a sheet based on the image formation data and the copy instruction information included in the input image data file generated by the image reading unit 200. The printer unit 130 may form an image on a sheet based on the image formation data and the print instruction information included in the input image data file transmitted from the terminal device 10. The printer unit 130 is an example of the image forming unit.

The printer unit 130 may be a device that fixes a visible image such as a toner image on a sheet to form an image or may be a device that forms an image in an inkjet scheme. The sheet is, for example, paper or label paper. However, the sheet may be any object if the image forming apparatus 100 can form an image on the surface of the object. The sheet may be a sheet stored in the sheet storing unit 140 or may be a sheet manually inserted into the image forming apparatus 100.

The sheet storing unit 140 stores sheets used for image formation by the printer unit 130.

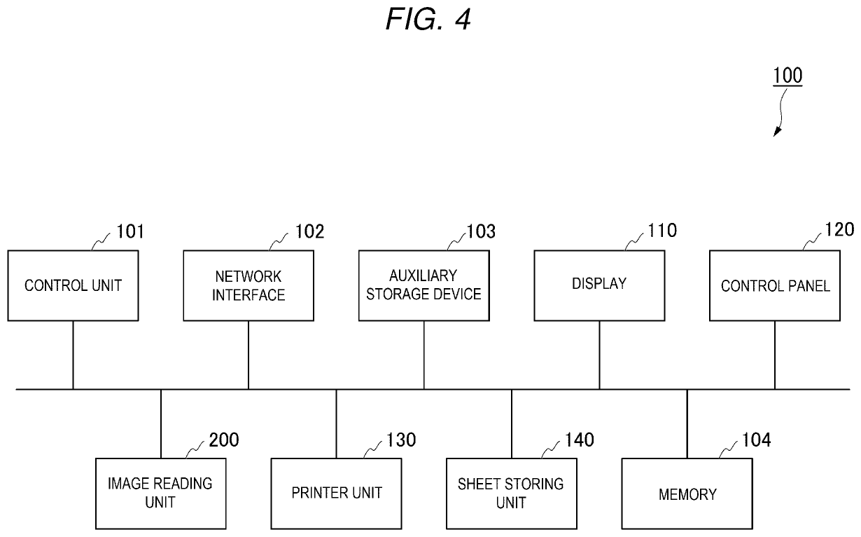

Subsequently, a hardware configuration of the image forming apparatus 100 in the embodiment is explained with reference to FIG. 4. FIG. 4 is a block diagram illustrating the hardware configuration of the image forming apparatus 100.

The image forming apparatus 100 includes the control unit 101, a network interface 102, an auxiliary storage device 103, a memory 104, the display 110, the control panel 120, the printer unit 130, the sheet storing unit 140, and the image reading unit 200. These components included in the image forming apparatus 100 are connected by an internal bus and can exchange data with one another. The functional units explained with reference to FIG. 3 are denoted by the same reference numerals and signs as those in FIG. 3 and explanation of the functional units is omitted.

The control unit 101 controls the operations of the components of the image forming apparatus 100. The control unit 101 executes a program to thereby cause the components to executes various kinds of processing. The program is stored in, for example, the memory 104 or the auxiliary storage device 103 in advance. A functional configuration of the control unit 101 is explained in detail below.

The network interface 102 transmits and receives data to and from an external device. The network interface 102 operates as an input interface and receives data transmitted from the external device. The network interface 102 operates as an output interface and transmits data to the external device.

The network interface 102 is communicatively connected to the terminal device 10 via a communication line such as a LAN and transmits and receives various kinds of information. For example, the network interface 102 receives an input image data file and print instruction information transmitted from the terminal device 10.

The network interface 102 is communicatively connected to the translation service provision server 30 via the Internet 50 and transmits and receives various kinds of information. For example, the network interface 102 transmits translation request information to the translation service provision server 30. For example, the network interface 102 receives translation result information transmitted from the translation service provision server 30.

The network interface 102 is communicatively connected to the font data distribution server 40 via the Internet 50 and transmits and receives various kinds of information. For example, the network interface 102 transmits font data request information to the font data distribution server 40. For example, the network interface 102 receives font data transmitted from the font data distribution server 40.

The auxiliary storage device 103 is a storage medium such as a HDD (Hard Disk Drive) or an SSD (Solid State Drive). The auxiliary storage device 103 stores various data. The various data are, for example, image formation data, an input image data file, and setting information. The setting information includes copy instruction information or print instruction information. The configuration of the information stored in the auxiliary storage device 103 is explained in detail below.

The memory 104 is a storage medium such as a RAM (Random Access Memory). The memory 104 temporarily stores data and programs used by the components included in the image forming apparatus 100. Digital data such as image data generated by the image reading unit 200 may be recorded in the memory 104 instead of the auxiliary storage device 103.

The configuration of the control unit 101 and the configuration of the auxiliary storage device 103 of the image forming apparatus 100 in the embodiment are explained below.

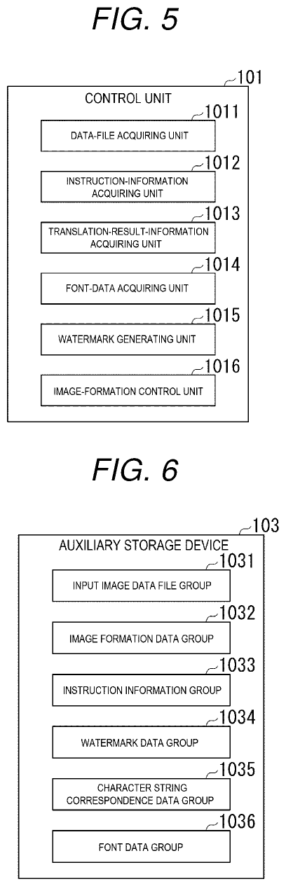

FIG. 5 is a block diagram illustrating a functional configuration of the control unit 101. The control unit 101 includes a data-file acquiring unit 1011, an instruction-information acquiring unit 1012, a translation-result-information acquiring unit 1013, a font-data acquiring unit 1014, a watermark generating unit 1015, and an image-formation control unit 1016.

FIG. 6 is a block diagram illustrating the configuration of the auxiliary storage device 103. The auxiliary storage device 103 stores an input image data file group 1031, an image formation data group 1032, an instruction information group 1033, a watermark data group 1034, a character string correspondence data group 1035, and a font data group 1036.

The data-file acquiring unit 1011 acquires an input image data file generated by the image reading unit 200 and an input image data file transmitted from the terminal device 10. The data-file acquiring unit 1011 causes the auxiliary storage device 103 to store the acquired input image data file. The data-file acquiring unit 1011 extracts one or a plurality of image formation data from the acquired input image data file and causes the auxiliary storage device 103 to store the one or the plurality of image formation data.

The instruction-information acquiring unit 1012 acquires copy instruction information generated based on an operation signal acquired from the control panel 120 and print instruction information transmitted from the terminal device 10. In the following explanation, if it is not particularly necessary to distinguish and explain the copy instruction information and the print instruction information, the copy instruction information and the print instruction information are simply referred to as “instruction information”. The data-file acquiring unit 1011 causes the auxiliary storage device 103 to store the acquired instruction information.

The translation-result-information acquiring unit 1013 acquires the copy instruction information generated based on the operation signal acquired from the control panel 120 or the print instruction information transmitted from the terminal device 10. The translation-result-information acquiring unit 1013 extracts, from the instruction information, a character string included in a watermark and information indicating a language designated by the user. The translation-result-information acquiring unit 1013 refers to the character string correspondence data group 1035 and acquires a character string obtained by translating the extracted character string into the extracted language.

If the character string obtained by translating the extracted character string into the extracted language is absent in the character string correspondence data group 1035, the translation-result-information acquiring unit 1013 transmits translation request information to the translation service provision server 30. As explained above, the translation request information includes a character string and information indicating a language. The translation-result-information acquiring unit 1013 acquires translation result information returned from the translation service provision server 30. The translation result information includes the character string obtained by translating the extracted character string into the extracted language.

In this embodiment, the translation-result-information acquiring unit 1013 is configured to acquire, from the translation service provision server 30, a character string translated into a language designated by the user but is not limited to this configuration. For example, the translation-result-information acquiring unit 1013 may be configured to collectively acquire, in advance, from the translation service provision server 30, character strings respectively translated into not only the language designated by the user but also a plurality of languages.

The font-data acquiring unit 1014 acquires the copy instruction information generated based on the operation signal acquired from the control panel 120 or the print instruction information transmitted from the terminal device 10. The font-data acquiring unit 1014 extracts, from the instruction information, information indicating the language designated by the user. The font-data acquiring unit 1014 refers to the font data group 1036 and determines whether font data of the extracted language is stored.

If the font data of the extracted language is absent in the font data group 1036, the font-data acquiring unit 1014 transmits font data request information to the font data distribution server 40. As explained above, the font data request information includes the information indicating the language designated by the user. The font-data acquiring unit 1014 acquires font data of a desired language returned from the font data distribution server 40.

In this embodiment, the font-data acquiring unit 1014 is configured to acquire, from the font data distribution server 40, font data of the language designated by the user but is not limited to this configuration. For example, the font-data acquiring unit 1014 may be configured to collectively acquire, in advance, from the font data distribution server 40, font data of not only the language designated by the user but also a plurality of languages.

The watermark generating unit 1015 generates, using the font data of the designated language, a watermark including a character string translated into the designated language.

The image-formation control unit 1016 generates a synthetic image obtained by adding the watermark generated by the watermark generating unit 1015 to the image formation data included in the input image data file. The image-formation control unit 1016 controls the printer unit 130 to form the generated synthetic image on a sheet.

In the following explanation, various data stored in the auxiliary storage device 103 illustrated in FIG. 6 are explained. The input image data file group 1031 is a set of data obtained by accumulating the input image data file generated by the image reading unit 200 and the input image data file transmitted from the terminal device 10. The image formation data group 1032 is a set of data obtained by accumulating the image formation data included in the input image data file.

The instruction information group 1033 is a set of data obtained by accumulating the copy instruction information generated based on the operation signal acquired from the control panel 120 and the print instruction information transmitted from the terminal device 10. The watermark data group 1034 is a set of watermark data indicating a watermark stored in advance.

The character string correspondence data group 1035 is a set of data in which the character string and the language included in the translation request information transmitted to the translation service provision server 30 and the character string and the language included in the translation result information returned from the translation service provision server 30 are associated. That is, the character string correspondence data group 1035 is a set of character string correspondence data representing correspondence in the case in which a character string is represented by respective languages. The character string correspondence data group 1035 is a data group in which information indicating translation results accumulated if the character string is translated into other languages is stored to be reusable. Some character string correspondence data concerning character strings of predetermined languages such as English and the native language is stored in advance in the auxiliary storage device 103.

The font data group 1036 is a set of font data returned from the font data distribution server 40. Font data of the predetermined languages such as English and the naïve language are stored in advance in the auxiliary storage device 103.

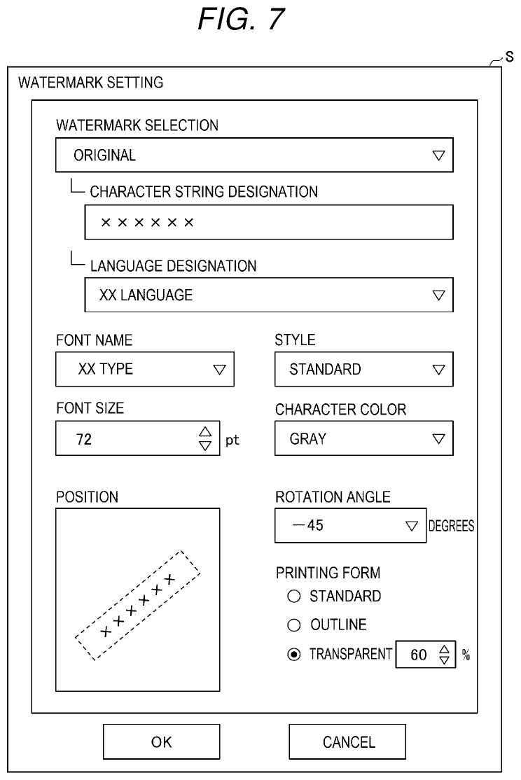

In the following explanation, an example of a watermark setting screen displayed if the user sets addition of a watermark is explained. FIG. 7 is a schematic diagram illustrating an example of the watermark setting screen. A watermark setting screen s illustrated in FIG. 7 is displayed on a display unit such as a liquid crystal display included in, for example, the display 110 or the terminal device 10.

As illustrated in FIG. 7, a plurality of input fields are provided on the watermark setting screen s. For example, the watermark setting screen s includes input fields of input items “watermark selection”, “character string designation”, “language designation”, “font name”, “style”, “font size”, “character color”, “position”, “rotation angle”, and “printing form”.

The input field of “watermark selection” is an input field for designating a type of a watermark to be added. The type of the watermark is a type such as a glyph, an icon, a logo, or an illustration. If a character string is included in the watermark, the type of the watermark is a type of the character string.

If the user adds a watermark including any character string, a value “original” is input to the input field of “watermark selection”. For example, the user only has to select the value “original” out of a pulldown menu displayed in the input field of “watermark selection”. If the value “original” is input to the input field of “watermark selection”, an input to the input field of “character string designation” is possible.

If the character string included in the watermark to be added is changed to any character string, the input field of “character string designation” is an input field for designating the character string. Even if the user desires to designate the character string in a language that the user himself or herself does not understand, the user does not need to input the character string in the language that the user does not understand. The user only has to input the character string in a language to which the image forming apparatus 100 is adapted in advance such as English or the native language. This is because, as explained above, translation of the character string included in the watermark into another language is performed by the multi-function peripheral system 1.

The input field of “language designation” is an input field for designating a language of the character string included in the watermark to be added. If a value indicating the watermark including the character string is input to the input field of “watermark selection”, an input to the input field of “language designation” is possible.

The input field of “font name” is an input field for designating a font of the character string included in the watermark to be added. The input field of “style” is an input field for designating a style of the character string included in the watermark to be added. The style is, for example, thickness of a character, whether the style is italic, or presence or absence of an underline. The input field of “font size” is an input field for designating a size of the character string included in the watermark to be added. The input field of “character color” is an input field for designating a color of the character string included in the watermark to be added.

The input field of “position” is an input field for designating a position where the watermark is added in an image based on the image formation data. For example, as illustrated in FIG. 7, the user can designate a position by dragging an image region of the watermark surrounded by a broken line and displayed in the input field of “position”.

The input field of “rotation angle” is an input field for designating a rotation angle of the watermark to be added. For example, as illustrated in FIG. 7, if “−45” is input to the input field of “rotation angle”, the watermark rotated 45 degrees counterclockwise with respect to the perpendicular direction of the image based on the image formation data is added. The user can check, in advance, in the input field of “position”, an image of the watermark rotated at the rotation angle designated in the input field of “rotation angle”.

The input field of “printing form” is an input field for selecting a printing form of the watermark to be added. For example, the user can select one out of three printing forms of “standard”, “outline”, and “transparent”. The printing form of “standard” is a printing form for painting out the character string included in the watermark with the color designated in the input field of “character color” and printing the character string. The printing form of “outline” is a printing form for printing the character string included in the watermark in an outline font style.

The printing form of “transparent” is a printing form for printing the watermark such that the watermark is seen through on the rear surface of the image based on the image formation data. As illustrated in FIG. 7, if the printing form of “transparent” is selected, an input to the input field for designating the transparency degree is possible. The user can designate a desired transparency degree with a value of a percentage form.

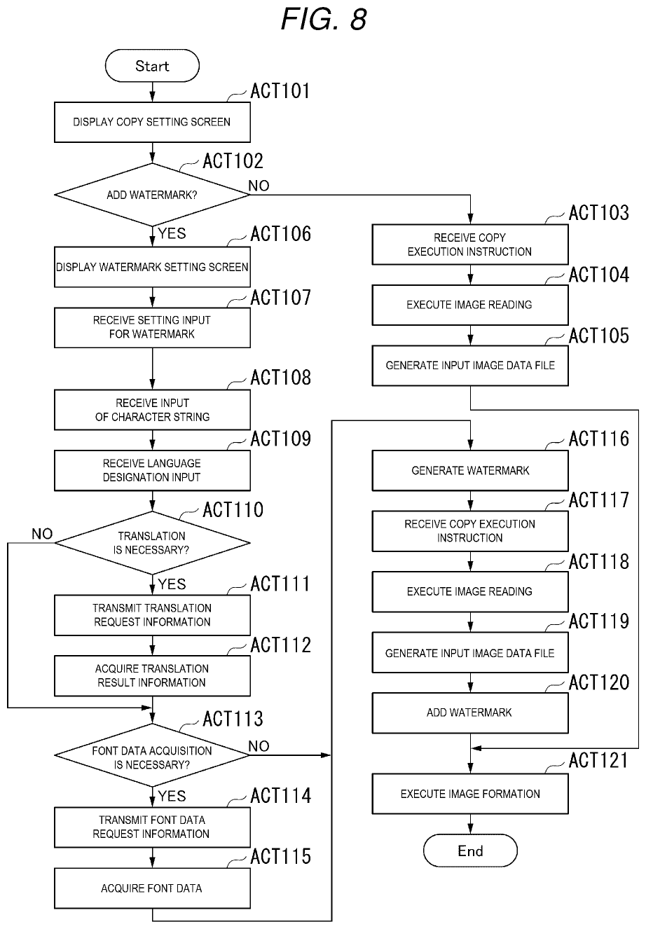

An operation of the image forming apparatus 100 in this embodiment is explained. FIG. 8 is a flowchart illustrating an example of the operation of the image forming apparatus 100. In the following explanation, as an example, an operation of the image forming apparatus 100 performed if the user instructs copying using the control panel 120 is explained. An operation performed if the user instructs printing using the terminal device 10 is basically the same as the operation of the image forming apparatus 100 indicated by the flowchart of FIG. 8.

The operation of the image forming apparatus 100 indicated by the flowchart of FIG. 8 is started, for example, if the user places a document on the document stand and performs input operation for performing copy setting. The input operation for performing the copy setting is performed using the control panel 120. If the user instructs printing, input operation for performing print setting is performed using the terminal device 10.

The display 110 displays a copy setting screen under control by the control unit 101 (ACT 101). The control panel 120 receives, on the copy setting screen, input operation for selecting whether a watermark is added. The control panel 120 outputs an operation signal indicating the received input operation to the control unit 101.

If the input operation signal is an operation signal indicating that a watermark is not added (NO in ACT 102), the control unit 101 waits for an input of an operation signal indicating a copy execution instruction based on the input operation of the user. The control unit 101 receives the input of the operation signal indicating the copy execution instruction (ACT 103).

The image reading unit 200 reads an image formed on the document placed on the document stand and generates image formation data under the control by the control unit 101 (ACT 104). The image reading unit 200 outputs the generated image formation data to the control unit 101. The control unit 101 generate an input image data file including the input image formation data and causes the auxiliary storage device 103 to store the input image data file (ACT 105).

The printer unit 130 forms, under the control by the control unit 101, an image on a sheet based on the image formation data included in the input image data file generated by the image reading unit 200 (ACT 121).

On the other hand, if the input operation signal is an operation signal indicating that a watermark is added (YES in ACT 102), the control unit 101 causes the display 110 to display a watermark setting screen (ACT 106). The watermark setting screen displayed on the display 110 is, for example, the watermark setting screen s illustrated in FIG. 7.

The control panel 120 receives input operation concerning setting of addition of a watermark by the user (ACT 107). The control panel 120 outputs, to the control unit 101, an operation signal indicating the input operation concerning the setting of addition of a watermark.

The control unit 101 receives, based on the input operation signal, an input of a character string designated on the watermark setting screen (ACT 108). As the designation of the character string, the user inputs a desired character string by selecting the desired character string out of character strings prepared in advance in some cases and the user directly inputs any character string in other cases. The control unit 101 receives an input of a language designated on the watermark setting screen (ACT 109).

The translation-result-information acquiring unit 1013 of the control unit 101 determines whether translation of the character string designated on the watermark setting screen is necessary (ACT 110). Specifically, the translation-result-information acquiring unit 1013 refers to the character string correspondence data group 1035 stored in the auxiliary storage device 103. If a character string obtained by translating the designated character string into the designated language is absent in the character string correspondence data group 1035, the translation-result-information acquiring unit 1013 determines that the translation is necessary.

If determining that the translation is necessary (YES in ACT 110), the translation-result-information acquiring unit 1013 transmits translation request information to the translation service provision server 30 (ACT 111). The translation-result-information acquiring unit 1013 waits for reception of translation result information returned from the translation service provision server 30. The translation-result-information acquiring unit 1013 acquires the translation result information (ACT 112).

The font-data acquiring unit 1014 of the control unit 101 determines whether acquisition of font data of the language designated on the watermark setting screen is necessary (ACT 113). Specifically, the font-data acquiring unit 1014 refers to the font data group 1036 stored in the auxiliary storage device 103. If the font data of the designated language is absent in the font data group 1036, the font-data acquiring unit 1014 determines that the acquisition of the font data is necessary.

If determining that the acquisition of the font data is necessary (YES in ACT 113), the font-data acquiring unit 1014 transmits font data request information to the font data distribution server 40 (ACT 114). The font-data acquiring unit 1014 waits for reception of font data returned from the font data distribution server 40. The font data distribution server 40 acquires font data of the designated language (ACT 115).

The watermark generating unit 1015 of the control unit 101 generates, using the font data of the designated language, a watermark including the character string translated into the designated language (ACT 116).

The control unit 101 waits for an input of an operation signal indicating a copy execution instruction based on input operation of the user. The control unit 101 receives the input of the operation signal indicating the copy execution instruction (ACT 117). The image reading unit 200 reads the image formed on the document placed on the document stand and generate image formation data under the control by the control unit 101 (ACT 118). The image reading unit 200 outputs the generated image formation data to the control unit 101. The control unit 101 generates an input image data file including the input image formation data and causes the auxiliary storage device 103 to store the input image data file (ACT 119).

The image-formation control unit 1016 of the control unit 101 generates a synthetic image obtained by adding the watermark generated by the watermark generating unit 1015 to the image formation data included in the input image data file (ACT 120). The image-formation control unit 1016 controls the printer unit 130 to form the generated synthetic image on a sheet. The printer unit 130 forms, under the control by the control unit 101, the synthetic image generated by the image-formation control unit 1016 on the sheet (ACT 121).

Then, the operation of the image forming apparatus 100 indicated by the flowchart of FIG. 8 ends.

In the following explanation, hardware configuration examples of the terminal device 10, the translation service provision server 30, and the font data distribution server 40 are explained.

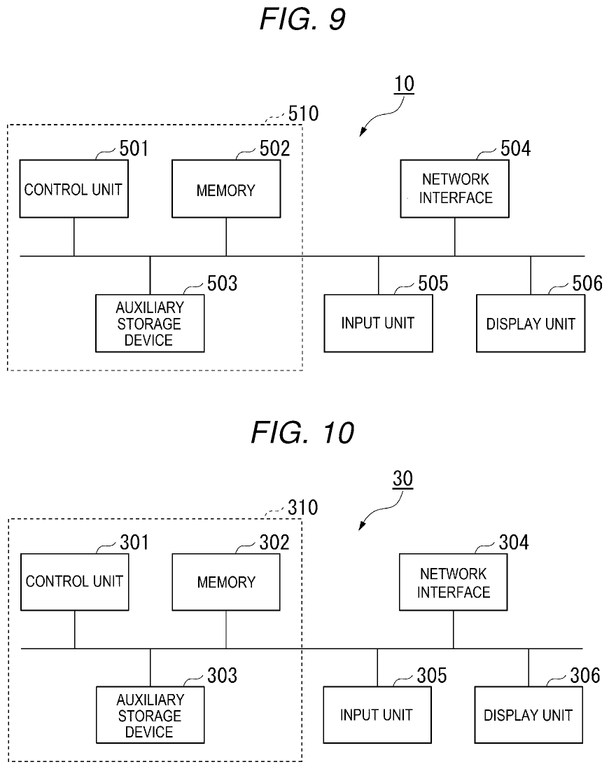

FIG. 9 is a diagram illustrating the hardware configuration example of the terminal device 10. As illustrated in FIG. 9, the terminal device 10 includes a control unit 501, a memory 502, an auxiliary storage device 503, a network interface 504, an input unit 505, and a display unit 506. These components included in the terminal device 10 are connected by an internal bus and can transmit and receive data to and from one another.

The control unit 501 reads out a program stored in the auxiliary storage device 503 to the memory 502 and executes the program, whereby the terminal device 10 functions as one information processing device that provides a print instructing function and the like. For example, the program referred to herein is a program such as a BIOS, an OS, or various kinds of firmware. The control unit 501, the memory 502, and the auxiliary storage device 503 function as a control device 510.

The control device 510 plays a role of a controller that causes the terminal device 10 to function as one information processing device that provides the print instructing function and the like. The configuration of the control device 510 is not limited to a specific configuration if the control device 510 is capable of causing, according to the execution of the program, the terminal device 10 to function as the information processing device that provides the print instructing function and the like.

The control device 510 has, for example, a function of storing data transferred from the image forming apparatus 100 in the auxiliary storage device 503. The control device 510 has, for example, a function of transferring data stored in the auxiliary storage device 503 to the image forming apparatus 100. The control device 510 stores, in the auxiliary storage device 503, various kinds of setting information necessary to realize these functions.

The control unit 501 includes a processor such as a CPU (Central Processing Unit). However, the control unit 501 may include another processor such as a GPU (Graphics Processing Unit). The memory 502 includes, for example, a RAM. However, the memory 502 may include another storage medium such as a ROM (Read Only Memory).

The auxiliary storage device 503 is configured using a storage device such as a magnetic hard disk device or a semiconductor storage device. The auxiliary storage device 503 stores, in advance, various kinds of information necessary to realize functions of the control device 510. The auxiliary storage device 503 stores, for example, attachment information transferred from the image forming apparatus 100.

The network interface 504 is an interface for communicatively connecting the terminal device 10 to the external device. The network interface 504 enables communicative connection between the terminal device 10 and the image forming apparatus 100. Consequently, the terminal device 10 can directly or indirectly transmit and receive information to and from the image forming apparatus 100.

The input unit 505 includes input devices such as a touch panel, a mouse, and a keyboard. The input unit 505 receives input operation to the terminal device 10 by the user. The input unit 505 outputs an operation signal based on the input operation to the control unit 501.

The display unit 506 includes a display device such as a liquid crystal display, an organic EL display, or a CRT (Cathode Ray Tube) display. The display unit 506 displays various kinds of information concerning the operation of the terminal device 10. The display unit 506 displays information based on the information output from the control unit 501.

All or a part of the functions of the terminal device 10 may be realized using hardware such as an ASIC (Application Specific Integrated Circuit), a PLD (Programmable Logic Device), or an FPGA (Field Programmable Gate Array). A program may be recorded in a computer-readable recording medium. The computer-readable recording medium is a portable medium such as a flexible disk, a magneto-optical disk, a ROM, or a CD-ROM or a storage device such as a hard disk incorporated in a computer system. The program may be transmitted via an electric communication line.

FIG. 10 is a diagram illustrating a hardware configuration example of the translation service provision server 30. As illustrated in FIG. 10, the translation service provision server 30 includes a control unit 301, a memory 302, an auxiliary storage device 303, a network interface 304, an input unit 305, and a display unit 306. These components included in the translation service provision server 30 are connected by an internal bus and can transmit and receive data to and from one another. The control unit 301 reads out a program stored in the auxiliary storage device to the memory 302 and executes the program, whereby the translation service provision server 30 functions as one information processing device that provides a translation service providing function and the like. For example, the program referred to herein is a program such as a BIOS, an OS, or various kinds of firmware. The control unit 301, the memory 302, and the auxiliary storage device 303 function as a control device 310.

The control device 310 plays a role of a controller that causes the translation service provision server 30 to function as one information processing device that provides the translation service providing function and the like. The configuration of the control device 310 is not limited to a specific configuration if the control device 310 is capable of causing, according to the execution of the program, the translation service provision server 30 to function as the information processing device that provides the print instructing function and the like.

The control device 310 has, for example, a function of storing data transferred from the image forming apparatus 100 in the auxiliary storage device 10. The control device 310 has, for example, a function of transferring data stored in the auxiliary storage device 303 to the image forming apparatus 100. The control device 310 stores, in the auxiliary storage device 303, various kinds of setting information necessary to realize these functions.

The control unit 301 includes a processor such as a CPU. However, the control unit 301 may include another processor such as a GPU. The memory 302 includes, for example, a RAM. However, the memory 302 may include another storage medium such as a ROM.

The auxiliary storage device 303 is configured using a storage device such as a magnetic hard disk device or a semiconductor storage device. The auxiliary storage device 303 stores, in advance, various kinds of information necessary to realize the functions of the control device 310. The auxiliary storage device 303 stores, for example, attachment information transferred from the image forming apparatus 100.

The network interface 304 is an interface for communicatively connecting the translation service provision server 30 to the external device. The network interface 304 enables communicative connection between the translation service provision server 30 and the image forming apparatus 100. Consequently, the translation service provision server 30 can directly or indirectly transmit and receive information to and from the image forming apparatus 100.

The input unit 305 includes input devices such as a touch panel, a mouse, and a keyboard. The input unit 305 receives input operation to the translation service provision server 30 by the user. The input unit 305 outputs an operation signal based on the input operation to the control unit 301.

The display unit 306 includes a display device such as a liquid crystal display, an organic EL display, or a CRT display. The display unit 306 displays various kinds of information concerning the operation of the translation service provision server 30. The display unit 306 displays information based on the information output from the control unit 301.

All or a part of the functions of the translation service provision server 30 may be realized using hardware such as an ASIC, a PLD, or an FPGA. A program may be recorded in a computer-readable recording medium. The computer-readable recording medium is a portable medium such as a flexible disk, a magneto-optical disk, a ROM, or a CD-ROM or a storage device such as a hard disk incorporated in a computer system. The program may be transmitted via an electric communication line.

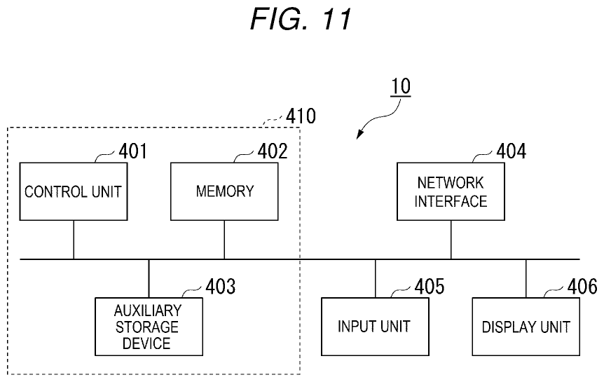

FIG. 11 is a diagram illustrating a hardware configuration example of the font data distribution server 40. As illustrated in FIG. 11, the font data distribution server 40 includes a control unit 401, a memory 402, an auxiliary storage device 403, a network interface 404, an input unit 405, and a display unit 406. These components included in the font data distribution server 40 are connected by an internal bus and can transmit and receive data to and from one another.

The control unit 401 reads out a program stored in the auxiliary storage device 403 and executes the program, whereby the font data distribution server 40 functions as one information processing device that provides a font data distributing function and the like. For example, the program referred to herein is a program such as a BIOS, an OS, or various kinds of firmware. The control unit 401, the memory 402, and the auxiliary storage device 403 function as a control device 410.

The control device 410 plays a role of a controller that causes the font data distribution server 40 to function as one information processing device that provides the font data distributing function and the like. The configuration of the control device 410 is not limited to a specific configuration if the control device 410 is capable of causing, according to the execution of the program, the font data distribution server 40 to function as an information processing device that provides the font data distributing function and the like.

The control device 410 has, for example, a function of storing data transferred from the image forming apparatus 100 in the auxiliary storage device 403. The control device 410 has, for example, a function of transferring data stored in the auxiliary storage device 403 to the image forming apparatus 100. The control device 410 stores, in the auxiliary storage device 403, various kinds of setting information necessary to realize these functions.

The control unit 401 includes a processor such as a CPU. However, the control unit 401 may include another processor such as a GPU. The memory 402 includes, for example, a RAM. However, the memory 402 may include another storage medium such as a ROM.

The auxiliary storage device 403 is configured using a storage device such as a magnetic hard disk device or a semiconductor storage device. The auxiliary storage device 403 stores, in advance, various kinds of information necessary to realize functions of the control device 410. The auxiliary storage device 403 stores, for example, attachment information transferred from the image forming apparatus 100.

The network interface 404 is an interface for communicatively connecting the font data distribution server 40 to the external device. The network interface 404 enables communicative connection between the font data distribution server 40 and the image forming apparatus 100. Consequently, the font data distribution server 40 can directly or indirectly transmit and receive information to and from the image forming apparatus 100.

The input unit 405 includes input devices such as a touch panel, a mouse, and a keyboard. The input unit 405 receives input operation to the font data distribution server 40 by the user. The input unit 405 outputs an operation signal based on the input operation to the control unit 401.

The display unit 406 includes a display device such as a liquid crystal display, an organic EL display, or a CRT display. The display unit 406 displays various kinds of information concerning the operation of the font data distribution server 40. The display unit 406 displays information based on the information output from the control unit 401.

All or a part of the functions of the font data distribution server 40 may be realized using hardware such as an ASIC, a PLD, or an FPGA. A program may be recorded in a computer-readable recording medium. The computer-readable recording medium is a portable medium such as a flexible disk, a magneto-optical disk, a ROM, or a CD-ROM or a storage device such as a hard disk incorporated in a computer system. The program may be transmitted via an electric communication line.

As explained above, the image forming apparatus 100 in this embodiment receives designation of an input image data file, a watermark including a character string, and a language. The image forming apparatus 100 forms, on a sheet, an image obtained by adding the designated watermark to image formation data based on the designated input image data file. At this time, according to necessity, the image forming apparatus 100 translates the character string included in the designated watermark into the designated language and adds the watermark to the image. If the image forming apparatus 100 is incapable of translating the character string in the own apparatus, the image forming apparatus 100 acquires the translated character string from the font data distribution server 40. If the image forming apparatus 100 does not have font data of the designated language in the own apparatus, the image forming apparatus 100 acquires the font data from the font data distribution server 40.

With the image forming apparatus 100 in the embodiment configured as explained above, the user is capable of designating any language as the language of the character string included in the watermark to be added. The user is capable of designating a language that the user himself or herself does not understand. Consequently, the image forming apparatus 100 in the embodiment can add, to the sheet, a watermark obtained by translating the character string into an appropriate language according to a sheet distribution target person. Accordingly, the image forming apparatus 100 in the embodiment can cause people using various languages to recognize a meaning of the watermark added to the sheet.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image forming apparatus, comprising:
an instruction-information acquisition component configured to acquire information indicating a first character string described in a first language and information indicating a second language different from the first language;
a translation-result-information acquisition component configured to acquire, from a translation service provision server, information indicating a second character string obtained by translating the first character string into the second language;
a font-data acquisition component configured to acquire font data of the second language from a font data distribution server;
an image-formation controller configured to generate a synthetic image obtained by adding the second character string having a font based on the font data to a formation target image; and
an image forming component configured to form the synthetic image on a sheet.

2. The image forming apparatus according to claim 1, wherein the first character string and the second character string are included in a watermark.

3. The image forming apparatus according to claim 1, wherein at least one of the translation service provision server and the font data distribution server is a server device that provides a Cloud-type service via an Internet.

4. The image forming apparatus according to claim 1, wherein a translation service provided by the translation service provision server is a translation service provided by Google LLC (registered trademark) or Excite Japan Co., Ltd. (registered trademark).

5. The image forming apparatus according to claim 1, further comprising a storing component configured to associate and store character strings translated and translated character strings, wherein
the translation-result-information acquisition component acquires the information indicating the second character string from the storing component if the information indicating the second character string is stored in the storing component and acquires the information indicating the second character string from the translation service provision server if the information indicating the second character string is not stored in the storing component.

6. The image forming apparatus according to claim 1, further comprising a storing component configured to store font data for each language, wherein
the font-data acquisition component acquires the font data of the second language from the storing component if the font data of the second language is stored in the storing component and acquires the font data of the second language from the font data distribution server if the font data of the second language is not stored in the storing component.

7. The image forming apparatus according to claim 1, wherein the translation-result-information acquisition component further acquires information indicating a character string obtained by translating the first character string into at least one language different from the first language and the second language.

8. The image forming apparatus according to claim 1, wherein the font-data acquisition component further acquires font data of at least one language different from the first language and the second language.

9. An image forming method, comprising:
acquiring information indicating a first character string described in a first language and information indicating a second language different from the first language;
acquiring, from a translation service provision server, information indicating a second character string obtained by translating the first character string into the second language;
acquiring font data of the second language from a font data distribution server;
generating a synthetic image obtained by adding the second character string having a font based on the font data to a formation target image; and
forming the synthetic image on a sheet.

10. The image forming method according to claim 9, wherein the first character string and the second character string are included in a watermark.

11. The image forming method according to claim 9, wherein at least one of the translation service provision server and the font data distribution server provides information or font data by a Cloud-type service via an Internet.

12. The image forming method according to claim 9, wherein a translation service provided by the translation service provision server is a translation service provided by Google LLC (registered trademark) or Excite Japan Co., Ltd. (registered trademark).

13. The image forming method according to claim 9, further comprising:
storing and associating and character strings translated and translated character strings; and
acquiring the information indicating the second character string from a storing component if the information indicating the second character string is stored in the storing component and acquiring the information indicating the second character string from the translation service provision server if the information indicating the second character string is not stored in the storing component.

14. The image forming method according to claim 9, further comprising:
storing font data for each language; and
acquiring the font data of the second language from a storing component if the font data of the second language is stored in the storing component and acquiring the font data of the second language from the font data distribution server if the font data of the second language is not stored in the storing component.

15. The image forming method according to claim 9, further comprising:
acquiring information indicating a character string obtained by translating the first character string into at least one language different from the first language and the second language.

16. The image forming method according to claim 9, further comprising:
acquiring font data of at least one language different from the first language and the second language.

17. A non-transitory computer readable medium having program instructions embodied therewith, the program instructions executable by a processing component to cause the processing component to:
acquire information indicating a first character string described in a first language and information indicating a second language different from the first language;
acquire, from a translation service provision server, information indicating a second character string obtained by translating the first character string into the second language;
acquire font data of the second language from a font data distribution server;
generate a synthetic image obtained by adding the second character string having a font based on the font data to a formation target image; and
form the synthetic image on a sheet.

18. The non-transitory computer readable medium according to claim 17, wherein the first character string and the second character string are included in a watermark.

19. The non-transitory computer readable medium according to claim 17, further comprising:
store and associate and character strings translated and translated character strings; and
acquire the information indicating the second character string from a storing component if the information indicating the second character string is stored in the storing component and acquire the information indicating the second character string from the translation service provision server if the information indicating the second character string is not stored in the storing component.

20. The non-transitory computer readable medium according to claim 17, further comprising:
store font data for each language; and
acquire the font data of the second language from a storing component if the font data of the second language is stored in the storing component and acquire the font data of the second language from the font data distribution server if the font data of the second language is not stored in the storing component.
